(19) United States
(12) Patent Application Publication
(10) Pub. No.: US 2024/0404737 A1
(43) Pub. Date: Dec. 5, 2024

(54) MAGNET ELEMENT AND ELECTRICAL DEVICE

(71) Applicants: INOAC CORPORATION, Nagoya-shi, Aichi-ken (JP); NAGOYA INSTITUTE OF TECHNOLOGY, Nagoya-shi, Aichi-ken (JP)

(72) Inventors: Nobuyuki MAKIHARA, Okazaki-shi (JP); Hisashi TSURUTA, Anjo-shi (JP); Yasushi IDO, Nagoya-shi (JP); Yuhiro IWAMOTO, Gifu-shi (JP)

(73) Assignees: INOAC CORPORATION, Nagoya-shi, Aichi-ken (JP); NAGOYA INSTITUTE OF TECHNOLOGY, Nagoya-shi, Aichi-ken (JP)

(21) Appl. No.: 18/699,809

(22) PCT Filed: Oct. 28, 2022
(86) PCT No.: PCT/JP2022/040563

§ 371 Date: Apr. 9, 2024

(30) Foreign Application Priority Data
Oct. 29, 2021 (JP) 2021-177539

(51) Int. Cl. H01F 7/02; H01F 7/20

(52) U.S. Cl. CPC H01F 7/0205; H01F 7/20

(57) ABSTRACT

A magnet element includes a magnet part and a support made of an clastic resin and configured to support the magnet part, wherein the support is a foam.

### TECHNICAL FIELD

The present disclosure relates to a magnet element and an electrical device including the magnet element.

### BACKGROUND ART

As a conventional magnet element to be an element component of an electrical device such as a generator and a sensor, a magnet element is known in which a magnet part is supported by a metal member (see, for example, Patent Document 1).

### RELATED ART DOCUMENTS

### Patent Document

Patent Document 1: JP 3051758 U (FIG. 1)

### SUMMARY OF THE INVENTION

### Problems to be Solved by the Invention

The present disclosure provides a novel magnet element.

### Means of Solving the Problems

One aspect of the present invention made to solve the above problem is a magnet element including: a magnet part; and a support made of an elastic resin and configured to support the magnet part. The support is a foam.

### BRIEF DESCRIPTION OF THE DRAWINGS

FIG. 1 is a cross-sectional view of an electrical device in a state of being attached to a suspension of a vehicle according to a first embodiment of the present disclosure.

FIG. 2 is a conceptual diagram of the electrical device.

FIG. 3 is a perspective view of a magnet element.

FIG. 4(A) is a cross-sectional view of the magnet element before compressive deformation, and FIG. 4(B) is a cross-sectional view of the magnet element under compressive deformation.

FIG. 5(A) is a cross-sectional view of a magnet element before compressive deformation in an electrical device according to a third embodiment, and FIG. 5(B) is a cross-sectional view of the magnet element under compressive deformation.

FIG. 6 is a circuit diagram of an electrical device according to a fifth embodiment.

FIG. 7 is a perspective view of the electrical device.

FIG. 8 is a cross-sectional side view of the electrical device.

FIG. 9 is a circuit diagram of an electrical device according to a sixth embodiment.

FIG. 10 is a conceptual diagram of an electrical device according to a seventh embodiment.

FIG. 11 is a cross-sectional view of an electrical device according to an eighth embodiment.

FIG. 12(A) is a cross-sectional view of a magnet element before compressive deformation in an electrical device according to a ninth embodiment, and FIG. 12(B) is a cross-sectional view of the magnet element under compressive deformation.

FIG. 13 is a perspective view of an electrical device according to a tenth embodiment.

FIG. 14 is a perspective view of an electrical device according to an eleventh embodiment.

FIG. 15 is a cross-sectional view of an electrical device according to a twelfth embodiment.

FIG. 16 is a perspective view of an electrical device according to a thirteenth embodiment.

FIG. 17 is a cross-sectional view of an electrical device in a state of being attached to a suspension of a vehicle according to a fourteenth embodiment.

FIG. 18(A) is a cross-sectional view of a magnet element before compressive deformation, and FIG. 18(B) is a cross-sectional view of the magnet element under compressive deformation.

FIG. 19 is a cross-sectional view of an electrical device according to another example of the fourteenth embodiment.

FIG. 20 is a conceptual diagram of a testing apparatus.

FIG. 21 is a graph of a frequency and an induced electromotive force in confirmation experiment 1.

FIG. 22 is a cross-sectional view of a magnet element in confirmation experiment 2.

FIG. 23 is a table of a frequency and an induced electromotive force in confirmation experiment 2.

FIG. 24 is a cross-sectional view of a magnet element according to a modification.

FIG. 25 is a cross-sectional view of a magnet element according to a modification.

FIG. 26 is a cross-sectional view of an electrical device according to a modification.

### DESCRIPTION OF EMBODIMENTS

### First Embodiment

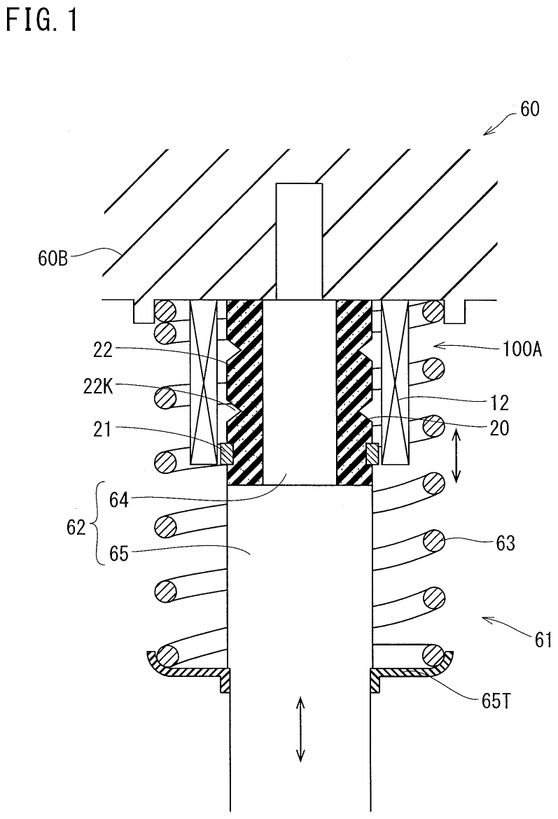

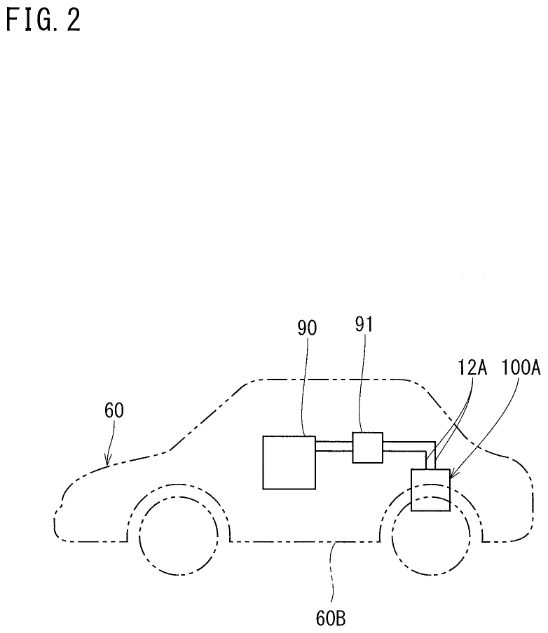

An electrical device 100A according to an embodiment of the present disclosure will be described with reference to FIGS. 1 to 4. As illustrated in FIGS. 1 and 2, the electrical device 100A according to the present embodiment is a generator, and is attached to a suspension 61 of a vehicle 60 to charge a battery 90 of the vehicle 60.

As illustrated in FIG. 1, the suspension 61 of the vehicle 60 includes a shock absorber 62 and a suspension spring 63. The suspension spring 63 is sandwiched between an annular protruding portion 65T protruding outward from a cylinder 65 of the shock absorber 62 and a vehicle body 60B. A magnet element 20 included in the electrical device 100A of the present embodiment is fitted to a piston rod 64 of the shock absorber 62.

In the present embodiment, an automobile is exemplified as the vehicle 60. However, for example, the electrical device 100A may also be applied to a vehicle suspension of a two-wheeled vehicle, a train, and the like. In addition, examples of the automobile include electric vehicles such as an electric car, a hybrid car, and a plug-in hybrid car.

The electrical device 100A includes an electromagnetic induction coil 12 and the magnet element 20 disposed inside the electromagnetic induction coil 12. The electromagnetic induction coil 12 has a cylindrical shape having an outer diameter that fits inside the suspension spring 63 and an axial length that is equal to or slightly shorter than that of the piston rod 64 in its longest state. One end of the electromagnetic induction coil 12 is fixed to the vehicle body 60B. In addition, a pair of lead wires 12A of the electromagnetic induction coil 12 is drawn out into the vehicle body 60B and connected to the battery 90 via a rectifier 91 (see FIG. 2).

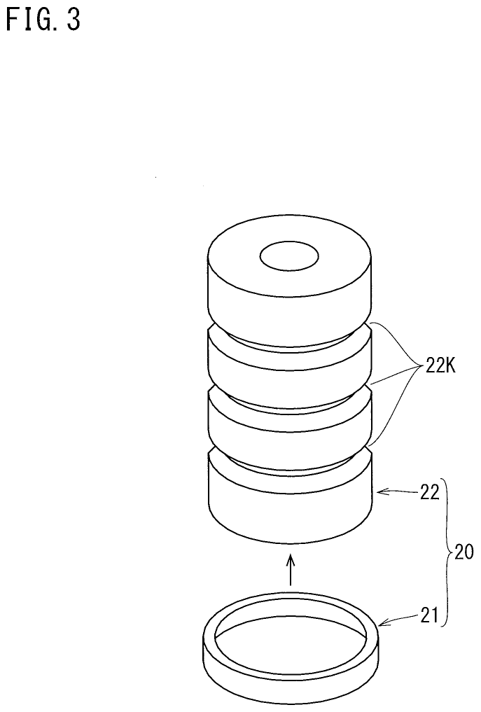

The magnet element 20 includes a magnet part 21 and an elastic resin support 22 that supports the magnet part 21. The support 22 has a cylindrical shape having an outer diameter substantially equal to that of the cylinder 65 and being fitted to the inside of the electromagnetic induction coil 12 with a gap therebetween, and has an axial length longer than that of the piston rod 64 in its longest state when the support 22 is in a natural length state. As illustrated in FIG. 3, a plurality of constricted portions 22K are formed on an outer side surface of the support 22. Opposite end surfaces of the support 22 are respectively fixed to a surface of the cylinder 65 and a surface of the vehicle body 60B with, for example, an adhesive while the piston rod 64 is inserted into the support 24 to compress the support 22. When the shock absorber 62 contracts, the support 22 is compressively deformed between the cylinder 65 and the vehicle body 60B to serve to reduce the bounce of the vehicle 60. The piston rod 64 in a shortest state has an axial length of, for example, approximately ½ of the piston rod 64 in the longest state.

The shape of the support 22 of the present embodiment is not limited to a circular cross section, and may be, for example, a polygonal cross section. In addition, the support 22 is not limited to an axially uniform cross section, and may have, for example, a shape that narrows toward one side in the axial direction. Furthermore, the constricted portions 22K may be evenly spaced in the axial direction of the support 22, or may be locally disposed. Moreover, the number of constricted portions 22K is not limited to plural, and may be only one, or the constricted portion 22K does not have to be provided.

The elastic resin forming the support 22 is a foamed elastomer, specifically, a polyurethane elastomer foam, and has an open-cell structure or a semi-open cell structure. In addition, the support 22 has an expansion ratio of 1.4 to 6 times. The support 22 may be a rubber foam, a foam of a thermoplastic resin such as a polyolefin-based resin, or the like. In addition, it is preferable that the entire support 22 has an open-cell structure or a semi-open cell structure from the viewpoint of moldability and easy elastic deformability. However, the support 22 may partially have the open-cell structure or the semi-open cell structure. Moreover, since the support 22 has the open-cell structure at least partially, it is possible to inhibit the support 22 from being reduced in size (so-called shrinking) after molding. Furthermore, the expansion ratio of the support 22 of the present embodiment is 1.4 to 6 times as described above, but is more preferably 1.7 to 5 times, and still more preferably 2 to 4 times. Here, when the expansion ratio of the support 22 is 1.4 times or more, the support 22 has a particularly favorable cushioning property, and when the expansion ratio is 6 times or less, the support 22 has particularly favorable moldability and durability.

The support 22 preferably has a compression set of 30% or less in accordance with JIS K 6262:2013 A method. In addition, the support 22 preferably has a cyclic compressive strain of 20% or less when repeatedly compressed by 50% for 100,000 times at 1 Hz. This configuration favorably restores the support 22 after elastically deforming the support 22.

The magnet part 21 is a rigid ring having an inner diameter smaller than the outer diameter of the support 22, and is engaged with the constricted portion 22K. In addition, the magnet part 21 is a neodymium-based magnet, and is magnetized in the axial direction, for example. As illustrated in FIG. 1, when the magnet element 20 is fitted to the piston rod 64, the magnet part 21 is disposed above a lower end of the electromagnetic induction coil 12.

The magnet part 21 is preferably a neodymium-based magnet having a strong magnetic force when formed into a permanent magnet. However, the magnet part 21 is not limited to the neodymium-based magnet, and may be a known magnet such as a samarium-based magnet, an alnico-based magnet, or a ferrite-based magnet.

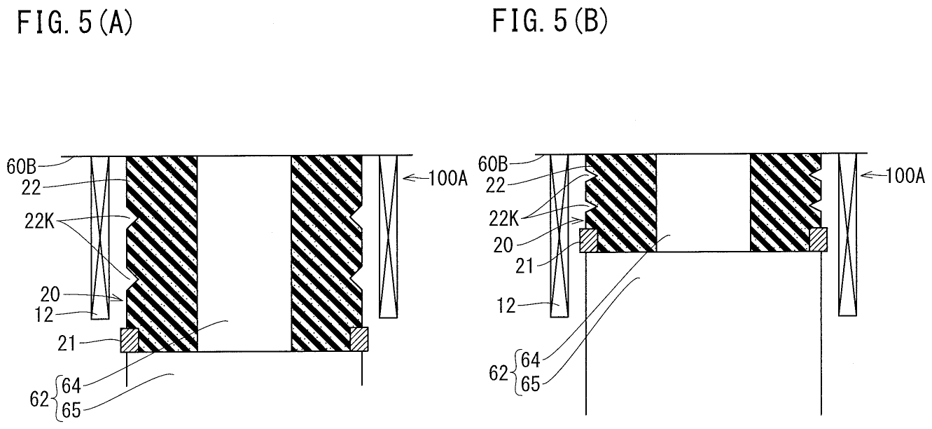

The number of magnet parts 21 is not limited to one, and a plurality of the magnet parts 21 may be provided. In addition, the magnet part 21 may be disposed on the outer side surface between the constricted portion 22K and the constricted portion 22K instead of on the constricted portion 22K. Furthermore, in a case where there is one magnet part 21, it is preferable to dispose the magnet part 21 on the constricted portion 22K closest to the cylinder 65 among the plurality of constricted portions 22K. However, the magnet part 21 may be disposed on any constricted portion 22K. The same applies to a case where the plurality of magnet parts 21 are provided. In addition, it is preferable that the magnet part 21 is disposed at a position away from an upper end surface of the cylinder 65 that presses the support 22, in other words, the magnet part 21 is disposed such as to interpose the support 22 between the magnet part 21 and the upper end surface of the cylinder 65 in the axial direction of the cylinder 65. However, the magnet part 21 may be disposed at an axial end of the support 22 so as to abut on the upper end surface of the cylinder 65 (see FIG. 5).

The structure of the electrical device 100A has been described above. The electrical device 100A is manufactured by the following method. First, the support 22 is manufactured in order to obtain the magnet element 20 that is an element component of the electrical device 100A. Specifically, a first liquid pre-polymerized by mixing a polyol and an isocyanate is prepared. Here, the first liquid is a prepolymer having an isocyanate group (NCO) at its terminal. In addition, a second liquid containing a catalyst, a foaming agent, and the like is prepared. Thereafter, the first liquid and the second liquid are mixed to obtain a mixed liquid. Here, the NCO % of the prepolymer having an isocyanate group at its terminal is preferably 3 to 7%, and is 6% in the present embodiment. This makes it possible to obtain the support 22 having excellent moldability and durability.

Next, the above mixed liquid is injected into a mold whose temperature has been controlled in advance, and is foamed and cured to form the cylindrical support 22 described above. In the step of foaming and curing the above mixed liquid in the mold, curing (primary curing) is performed in a closed-mold state for a predetermined time, and then the obtained foamed molded body is taken out from the mold. The primary curing is performed, for example, at 60 to 120° C. for 10 to 120 minutes. The foamed molded body taken out from the mold after the primary curing is preferably further subjected to secondary curing. The secondary curing is performed, for example, at 90 to 180° C. for 8 to 24 hours. As a result, the support 22 is obtained.

The magnet part 21 is attached to the support 22 manufactured as described above from one end side in the axial direction to obtain the magnet element 20, and the electromagnetic induction coil 12 is disposed outside the magnet element 20. As a result, the manufacture of the electrical device 100A is completed.

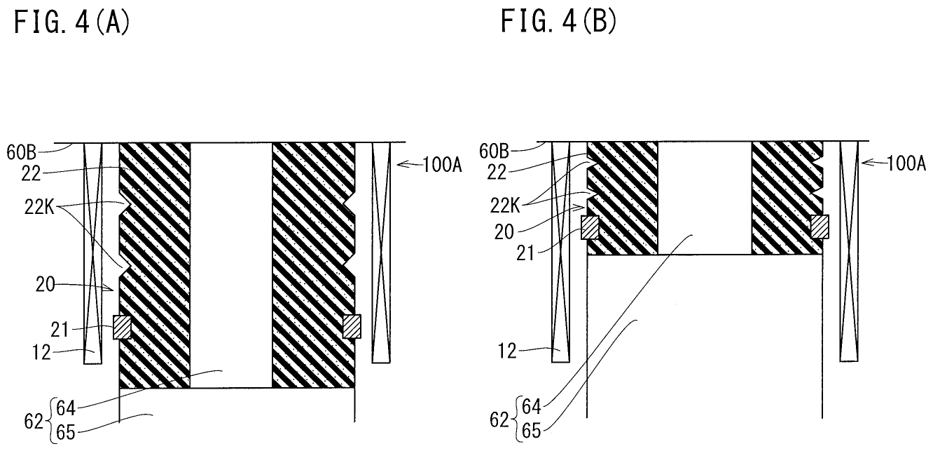

Next, operational effects of the electrical device 100A will be described. In the electrical device 100A, as described above, the magnet element 20 is set between the cylinder 65 and the vehicle body 60B. A change in a distance between the cylinder 65 and the vehicle body 60B extends and compresses the support 22 in the axial direction as illustrated by a change between FIGS. 4(A) and 4(B). Here, in the magnet element 20 of the present embodiment, the magnet part 21 is supported by the support 22, so that the magnet part 21 moves in the axial direction with respect to the electromagnetic induction coil 12 by the extension and compression of the support 22. This changes the density of magnetic flux passing through the electromagnetic induction coil 12 in a magnetic flux of a magnetic field by the magnet part 21, thereby generating an induced current. That is, the electrical device 100A generates power.

In the present embodiment, the support 22 is formed of a foamed elastomer. Therefore, air bubbles of the foamed elastomer are crushed when the support 22 is compressed in the axial direction, and the air bubbles expand when the support 22 is extended, so that the support 22 is extended and compressed almost without a change in size in a radial direction. In addition, the support can be extended and compressed with a larger stroke as compared with a case where the support is formed of an elastic body of a typical resin including a non-foamed elastomer, a metal, and the like. That is, since the magnetic flux density can be greatly changed by reciprocating the magnet part 21 with a large stroke by the deformation of the support 22 with a large stroke, the amount of power generated per stroke can be increased as compared with a case where the magnetic flux density can be changed only with a short stroke.

As described above, the induced current generated in the electrical device 100A is applied to the battery 90 through the rectifier 91 mounted in the vehicle 60 to charge the battery 90.

As described above, since the magnet element 20 of the present embodiment has a novel configuration in which the magnet part 21 is supported by the elastic resin support 22, the following effects are obtained by applying the magnet element 20 to the electrical device 100A as a generator. That is, in the electrical device 100A of the present embodiment, since the support 22 that supports the magnet part 21 is a foamed elastomer, it is possible to increase the amount of power generated per stroke by extending and compressing the support 22 with a large stroke. In addition, since the constricted portions 22K are formed on the outer side surface of the support 22, the support 22 can be easily extended and compressed. Furthermore, since the support 22 can be inhibited from changing in size in the radial direction due to the extension and compression as described above, interference with the electromagnetic induction coil 12 can be inhibited, and a clearance between the support 22 and the electromagnetic induction coil 12 outside the support 22 can be narrowed to increase power generation efficiency. Moreover, since the support 22 is lightweight and is hardly damaged, the support 22 is easy to handle.

In the present embodiment, the magnet part 21 is disposed on the surface (specifically, the outer side surface) of the support 22, so that the magnet part 21 can be brought close to the electromagnetic induction coil 12, and an electromotive force can be increased. In addition, since the magnet part 21 is a rigid ring, buckling of the support 22 during compression can be inhibited. Moreover, in the present embodiment, the magnet part 21 is disposed such as to interpose the support 22 between the magnet part 21 and the upper end surface of the cylinder 65 in the axial direction of the support 22. It is possible to protect the magnet part 21 by inhibiting the magnet part 21 from abutting on the cylinder 65 when the magnet element 20 is extended and compressed.

### Second Embodiment

The electrical device 100A of the above first embodiment includes the magnet element 20 and the electromagnetic induction coil 12, and is connected to the external rectifier 91 and the battery 90 as a load unit. However, the electrical device may integrally include a rectifier and a load unit in addition to the magnet element 20 and the electromagnetic induction coil 12.

### Third Embodiment

The present embodiment differs from the electrical device 100A of the above first embodiment only in the position of the magnet part 21 of the magnet element 20 with respect to the electromagnetic induction coil 12. Specifically, as illustrated in FIG. 5(A), the magnet part 21 of the magnet element 20 of the present embodiment is disposed so as to be positioned below the lower end of the electromagnetic induction coil 12 when the piston rod 64 is in the longest state. The magnet part 21 is configured to reciprocate between the inside and the outside of the electromagnetic induction coil 12 by a change in the distance between the cylinder 65 and the vehicle body 60B.

### Fourth Embodiment

The present embodiment differs from the magnet element 20 of the above first embodiment only in that the magnet part 21 is re-magnetized in a direction in which the support 22 is compressed (in other words, the axial direction of the magnet part 21) before or after the magnet part 21 is attached to the support 22.

### Fifth Embodiment

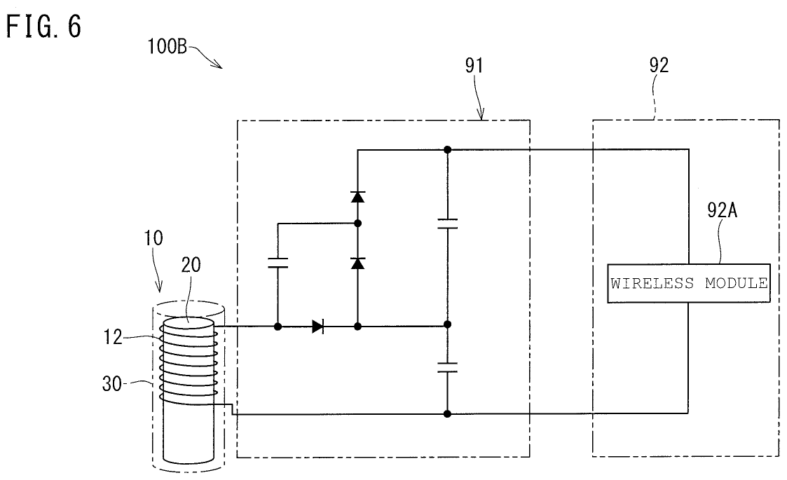

An electrical device 100B of the present embodiment is illustrated in FIGS. 6 to 8. In the above first embodiment, the electrical device 100A as a generator has been exemplified, whereas in the present embodiment, the electrical device 100B as a sensor will be described. As illustrated in FIG. 6, the electrical device 100B of the present embodiment includes a power generation unit 10, a rectifier 91, and a load unit 92. Hereinafter, only configurations different from those of the first embodiment will be described.

The load unit 92 includes, for example, a wireless module 92A. The wireless module 92A is, for example, a modification of RFID. While an RFID tag wirelessly receives power, modulates an identification number to a carrier of short-range wireless communication, and wirelessly transmits the identification number every time the power is received, the wireless module 92A receives power from a wire from the power generation unit 10 through the rectifier 91, modulates an identification number to a carrier wave of predetermined wireless communication, and transmits the identification number every time the power is received. Examples of the predetermined wireless communication include long-range wireless communication, Wi-Fi, infrared communication, and short-range wireless communication.

The wireless module 92A may modulate information other than the identification number to a carrier wave and wirelessly transmit the information, or may transmit only a radio wave of a specific frequency including no information without modulating information to a carrier wave, and transmitting the radio wave itself may be regarded as information from the electrical device 100B.

The rectifier 91 is, for example, a known voltage-multiplying rectifier circuit. An electromagnetic induction coil 12 of the power generation unit 10 described below is connected to the input side of the rectifier 91, and the wireless module 92A described above is connected to the output side thereof. An induced current induced in the electromagnetic induction coil 12 is rectified by the rectifier 91 and applied to the wireless module 92A.

Although a triple-voltage rectifier circuit is illustrated as the rectifier 91 in FIG. 6, an n-fold voltage rectifier circuit according to a desired voltage may be used.

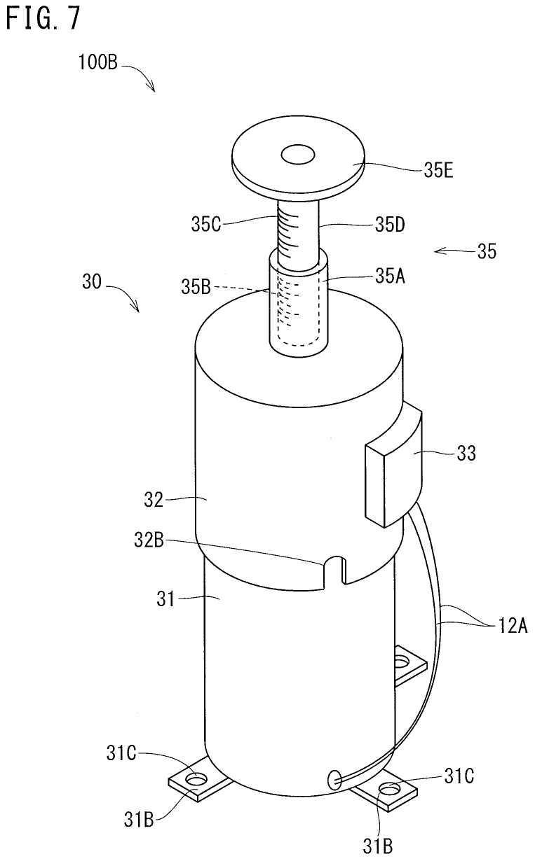

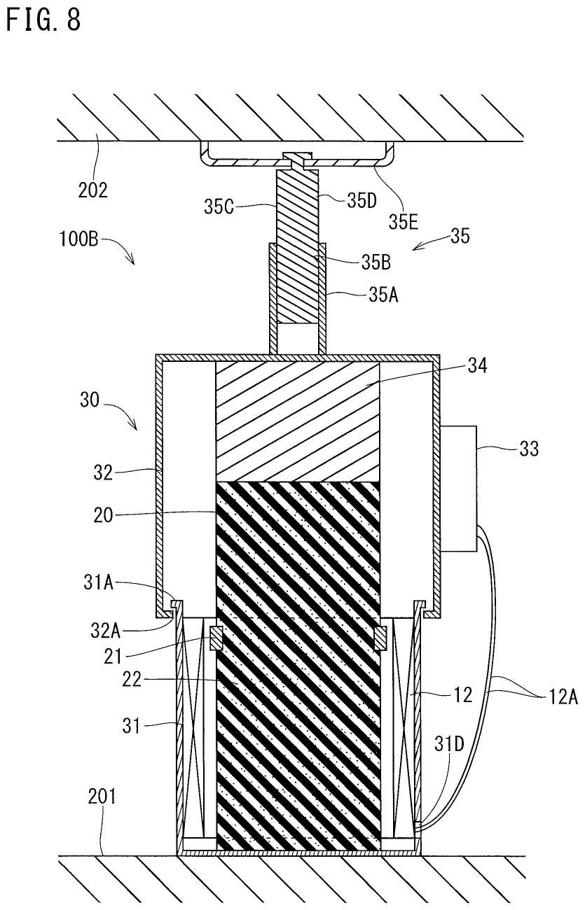

The power generation unit 10 includes the electromagnetic induction coil 12, a magnet element 20 disposed inside the electromagnetic induction coil 12, and a telescopic case 30 that accommodates the electromagnetic induction coil 12 and the magnet element 20. As illustrated in FIGS. 7 and 8, the telescopic case 30 has a structure in which a cylindrical body 31 bottomed at one end and opened at the other end, and a cylindrical body 32 bottomed at one end and opened at the other end, the cylindrical body 32 having an outer diameter larger than that of the cylindrical body 31, are fitted with the open ends facing each other. In addition, axial lengths of the cylindrical bodies 31 and 32 are substantially equal to each other, and fold-back portions 31A and 32A that engage with each other to prevent detachment are provided at the open ends of the cylindrical bodies 31 and 32. The telescopic case 30 changes between a longest state in which the fold-back portions 31A and 32A engage with each other and a shortest state in which the open end of the one cylindrical body 31 abuts on the bottom of the other cylindrical body 32. The telescopic case 30 in the shortest state has an axial length of, for example, approximately ½ of the telescopic case 30 in the longest state.

A circuit case 33 accommodating the rectifier 91 and the load unit 92 described above is fixed to an outer surface of the cylindrical body 32. In addition, a plurality of protruding pieces 31B protruding laterally from a plurality of positions in a circumferential direction are provided at a bottom wall side end of the one cylindrical body 31, and an attachment hole 31C is formed in each of the protruding pieces 31B. Moreover, for example, an adjustment mechanism 35 is provided at a distal end of the other cylindrical body 32. The adjustment mechanism 35 includes a support cylinder 35A protruding from the center of an outer surface of a bottom wall of the cylindrical body 32 and having a female threaded portion 35B on its inner surface, a shaft part 35D having a male threaded portion 35C to be screwed with the female threaded portion 35B on its outer surface, and a contacting plate 35E that is rotatably attached to a distal end of the shaft part 35D.

The telescopic case 30 of the present embodiment is, for example, a non-magnetic body such as resin or stainless steel. However, the telescopic case 30 and a spacer 34 described later may be formed of a magnetic body such as iron to form a magnetic path together with the magnet element 20 described later. In addition, the cylindrical bodies 31 and 32 of the present embodiment are connected to each other so as not to be rotatable by being connected via the magnet element 20. However, a vertically long engagement groove may be provided in one of the cylindrical bodies 31 and 32, and a protruding portion to be engaged with the engagement groove may be provided in the other one to regulate relative rotation between the cylindrical bodies 31 and 32.

As illustrated in FIG. 8, the electromagnetic induction coil 12 has, for example, a cylindrical shape with an outer diameter and an axial length that just fit inside the one cylindrical body 31, and is fixed inside the cylindrical body 31. In addition, a pair of lead wires 12A of the electromagnetic induction coil 12 is drawn out to the side of the cylindrical body 31 through a through hole 31D that passes through a side wall close to the bottom wall of the cylindrical body 31. The pair of lead wires 12A is taken into the circuit case 33 and connected to the rectifier 91. The pair of lead wires 12A is bent as the telescopic case 30 extends and contracts. A notch 32B (see FIG. 7) for avoiding interference with the pair of lead wires 12A is formed at the opening-side end of the cylindrical body 32.

The magnet element 20 has a columnar shape fitted to the inside of the electromagnetic induction coil 12 with a gap therebetween, is disposed coaxially with the telescopic case 30, and has opposite end surfaces fixed to bottom surfaces of the cylindrical bodies 31 and 32 with, for example, an adhesive. In addition, the columnar spacer 34 having the same outer diameter as that of the magnet element 20 is disposed between one end surface of the magnet element 20 and the bottom surface of the cylindrical body 32 as necessary to adjust the compressibility of the magnet element 20. Specifically, in a case where the spacer 34 is not provided, the magnet element 20 in the telescopic case 30 is compressed to ½ similarly to the telescopic case 30 by changing the telescopic case 30 from the longest state to the shortest state. Meanwhile, in a case where the above spacer 34 is provided, the compressibility of the magnet element 20 can be increased to any compressibility of ½ or more. FIG. 8 illustrates a structure in which the magnet element 20 including the spacer 34 is compressed to ⅓.

The magnet element 20 is slightly compressed between the bottom surfaces of the cylindrical bodies 31 and 32 in the longest state of the telescopic case 30. This prevents a backlash between the cylindrical bodies 31 and 32 in a state where the telescopic case 30 is not subjected to an external force.

The magnet element 20 is fixed to the cylindrical bodies 31 and 32 with an adhesive, but does not have to be fixed. In addition, the bottom surfaces of the cylindrical bodies 31 and 32 and the opposite end surfaces of the magnet element 20 may be provided with recesses and protrusions for centering the magnet element 20 with respect to the telescopic case 30 by the recesses and protrusions being fitted to each other.

The structure of the electrical device 100B of the present embodiment has been described above. Next, operational effects of the electrical device 100B will be described. As illustrated in FIG. 8, the electrical device 100B is set in a gap between a pair of facing members 201 and 202 in which a distance between the members may vary, and is used to detect deformation/motion or the like of the pair of facing members 201 and 202. For this purpose, the electrical device 100B is disposed such that the axial direction of the telescopic case 30 (the axial direction of the electromagnetic induction coil 12 and the magnet element 20 as well) is aligned with a facing direction of the pair of facing members 201 and 202. For example, the adjustment mechanism 35 is adjusted such that the telescopic case 30 is in a desired state when the distance between the pair of facing members 201 and 202 is in a normal state. Specifically, in the case of detecting both of a case where the pair of facing members 201 and 202 separates from each other from the normal state and a case where the pair of facing members 201 and 202 approaches each other from the normal state, the adjustment mechanism 35 is adjusted such that the telescopic case 30 is in a compressed state of approximately ½ of the longest state. In addition, in the case of detecting only the approach of the pair of facing members 201 and 202 from the normal state, the adjustment mechanism 35 is adjusted such that the telescopic case 30 is slightly compressed between the pair of facing members 201 and 202 in the normal state or such that the contacting plate 35E of the adjustment mechanism 35 is slightly separated from the one facing member 202. In addition, in order to prevent the electrical device 100B from being laterally displaced from the pair of facing members 201 and 202, it is preferable to fix the telescopic case 30 to the one facing member 201 by, for example, fastening a bolt passing through the attachment hole 31C of the telescopic case 30 to a threaded hole of the facing member 201 as necessary.

As described above, when the distance between the pair of facing members 201 and 202 changes in a state where the electrical device 100B is set between the pair of facing members 201 and 202, the magnet element 20 is extended and compressed in the axial direction together with the telescopic case 30. This changes the density of magnetic flux passing through the electromagnetic induction coil 12 in a magnetic flux of a magnetic field by the magnet element 20, so that the power generation unit 10 generates power. The induced current generated by the power generation unit 10 is rectified by the rectifier 91 and received by the load unit 92. The wireless module 92A of the load unit 92 then outputs a wireless signal including the information of the identification number. As a result, a wireless terminal located away from the electrical device 100B can receive the wireless signal from the electrical device 100B and monitor a load applied to the pair of facing members 201 and 202 and a behavior thereof.

It is possible to monitor a behavior, the presence or absence of abnormality, or the like of an elevated bridge or a building due to a typhoon, an earthquake, or the like by setting a plurality of the electrical devices 100B of the present embodiment in a gap between a bridge girder and a bridge body of an elevated bridge, a gap under a floor of a building having a base isolation structure, a gap under a road surface of a road, or the like, storing installation places and identification numbers of the electrical devices 100B in association, and monitoring wireless signals from the plurality of electrical devices 100B by a monitoring terminal.

### Sixth Embodiment

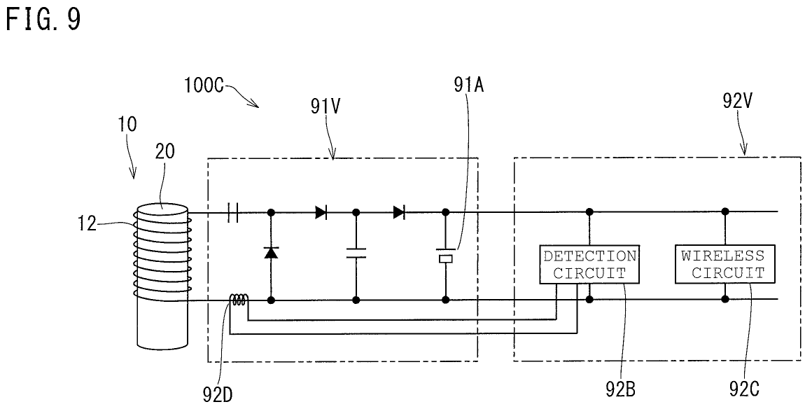

An electrical device 100C of the present embodiment is illustrated in FIG. 9, and differs from the above fifth embodiment in the configurations of a rectifier 91V and a load unit 92V. That is, the rectifier 91V is a double-voltage rectifier circuit, and a secondary battery 91A is connected between a pair of output terminals of the rectifier 91V. In addition, the load unit 92V includes a detection circuit 92B and a wireless circuit 92C. A current detector 92D for detecting an induced current flowing through the electromagnetic induction coil 12 is connected to the load unit 92V. The detection circuit 92B further includes an A/D converter and a microcomputer. Detection data for specifying an external force received by the electrical device 100C is generated on the basis of the induced current generated in the electromagnetic induction coil 12. The wireless circuit 92C wirelessly transmits the detection data. Examples of the detection data include various data such as FFT data and spectrum data of the induced current, and data on a peak value included in a waveform of the induced current.

In the electrical device 100C of the present embodiment, since the detection data for specifying an external force is generated on the basis of the induced current generated in the power generation unit 10 and then wirelessly transmitted, it is possible to collect data that is hardly affected by noise due to wireless transmission at a remote location away from the electrical device 100C. In addition, since the secondary battery 91A is provided, power supply to the load unit 92V becomes stable.

### Seventh Embodiment

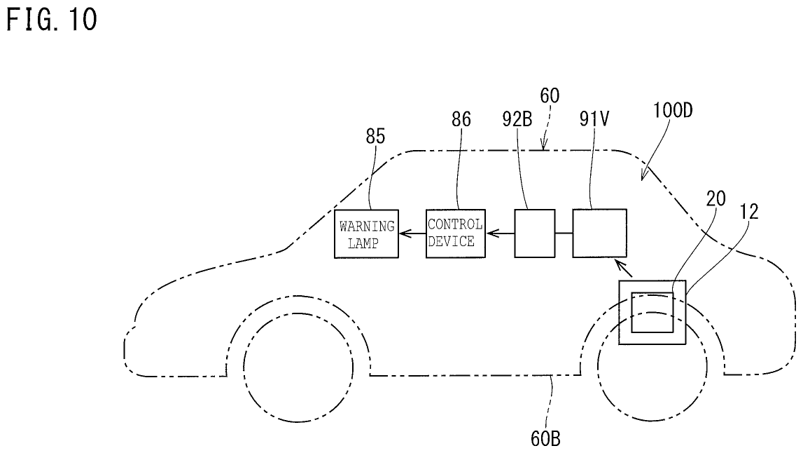

An electrical device 100D of the seventh embodiment is illustrated in FIG. 10, and has a configuration in which the rectifier 91V and the detection circuit 92B as a load unit similar to those of the electrical device 100C of the above sixth embodiment are added to the electrical device 100A of the above first embodiment. Detection data generated by the detection circuit 92B is provided to a control device 86 of the vehicle 60. The control device 86 determines the presence or absence of abnormality such as overloading of the vehicle 60 and malfunction of the suspension 61 on the basis of the provided detection data, and turns on a warning lamp 85 to notify a driver of the abnormality when the abnormality is present.

The electrical device 100D may be provided in a cargo bed of a truck as the vehicle 60 to detect an abnormality related to cargo overloading or a cargo weight balance of the cargo bed. In addition, the present embodiment is not limited to the configuration in which the electrical device 100D is provided in the vehicle 60 to detect an abnormality related to the vehicle 60, and for example, a configuration may be adopted in which the above electrical device 100D is provided in a tank or a pipe in a plant to detect an abnormality in the tank or the pipe.

### Eighth Embodiment

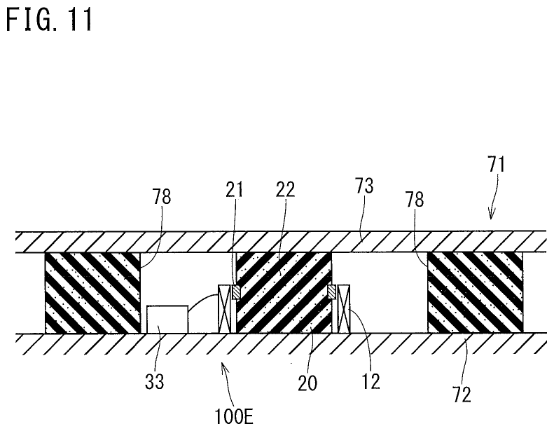

An electrical device 100E of the present embodiment is illustrated in FIG. 11, and is incorporated in a floor structure 71 of a building or a vehicle. Specifically, the floor structure 71 has a structure in which a floor panel 73 is laid on a base 72, and a plurality of cushioning materials 78 are laid between the base 72 and the floor panel 73. When a load is applied to the floor panel 73, the cushioning materials 78 are elastically deformed. One or some of the plurality of cushioning materials 78 is (are) the magnet element(s) 20, and the electromagnetic induction coil 12 is provided so as to surround the magnet element 20. In addition, the electrical device 100E includes the rectifier and the wireless module similar to those of the fifth embodiment, which are accommodated in the circuit case 33.

### Ninth Embodiment

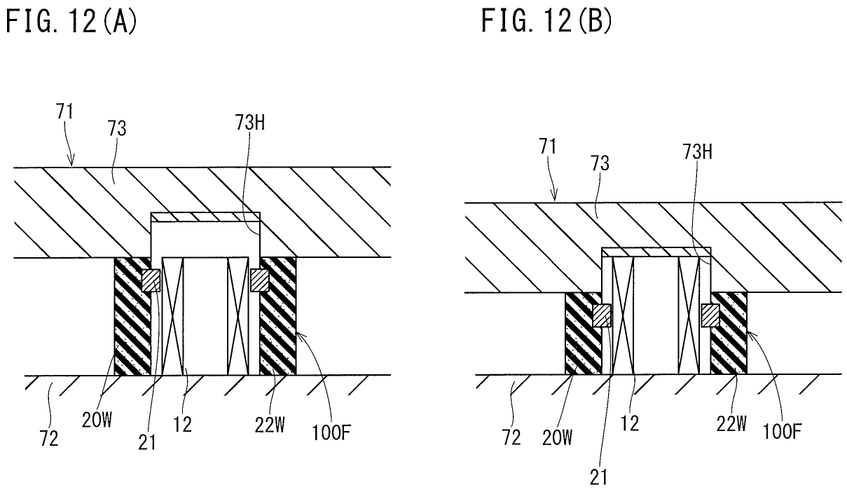

An electrical device 100F of the present embodiment is illustrated in FIGS. 12(A) and 12(B), and differs from the electrical device 100E of the eighth embodiment in the disposition of the electromagnetic induction coil 12. Specifically, in the electrical device 100F, a support 22W of a magnet element 20W has a cylindrical shape having an inner diameter larger than the electromagnetic induction coil 12, and the electromagnetic induction coil 12 is disposed inside the support 22W. In addition, the magnet part 21 has an outer diameter larger than the inner diameter of the support 22W and is disposed inside the support 22W. Furthermore, an accommodating part 73H is formed on a lower surface of the floor panel 73, and an upper end surface of the magnet element 20W is fixed to an opening edge of the accommodating part 73H. When a load is applied to the floor panel 73, the cushioning materials and the magnet element 20W are compressed, and an upper end of the electromagnetic induction coil 12 is accommodated in the accommodating part 73H of the floor panel 73 along with this compression. Although not illustrated, the electrical device 100F includes the rectifier and the wireless module similar to those of the fifth embodiment, which are accommodated in the circuit case.

### Tenth Embodiment

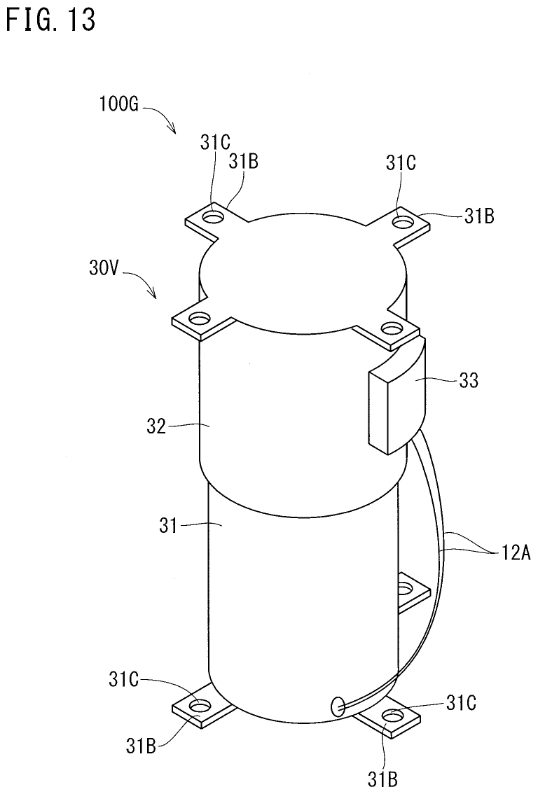

An electrical device 100G of the present embodiment is illustrated in FIG. 13, and the magnet element 20 is torsionally deformed by receiving an external force. Specifically, the electrical device 100G has a structure in which a twist case 30V excludes the adjustment mechanism 35 from the one cylindrical body 32 of the telescopic case 30 of the electrical device 100B of the fifth embodiment. The twist case 30V includes the plurality of protruding pieces 31B similar to those of the other cylindrical body 31 and is provided with the magnet element 20 and the electromagnetic induction coil 12 having the same shapes as the magnet element 20 and the electromagnetic induction coil 12 of the electrical device 100B of the fifth embodiment. The twist case 30V is attached to the middle of a pair of relatively rotating members or a shaft receiving a load torque. As a result, the pair of cylindrical bodies 31 and 32 relatively rotates by receiving an external force as a load torque, and the magnet element 20 is twisted. Other structures are similar to those of the electrical device 100B of the fifth embodiment.

The electrical device 100G has a different magnetization direction from that of the magnet part 21 of the magnet element 20 of the fifth embodiment. When the magnet element 20 is torsionally deformed in one direction, a magnetic moment of the magnet part 21 is aligned in a direction passing through the electromagnetic induction coil 12. When the magnet element 20 is torsionally deformed in the other direction, the magnetic moment of the magnet part 21 is aligned in a direction different from the direction passing through the electromagnetic induction coil 12 or is dispersed. As a result, the density of magnetic flux passing through the electromagnetic induction coil 12 is changed along with the torsional deformation of the magnet element 20 to generate power, and the wireless module 92A of the load unit 92 receives the power and transmits a wireless signal.

### Eleventh Embodiment

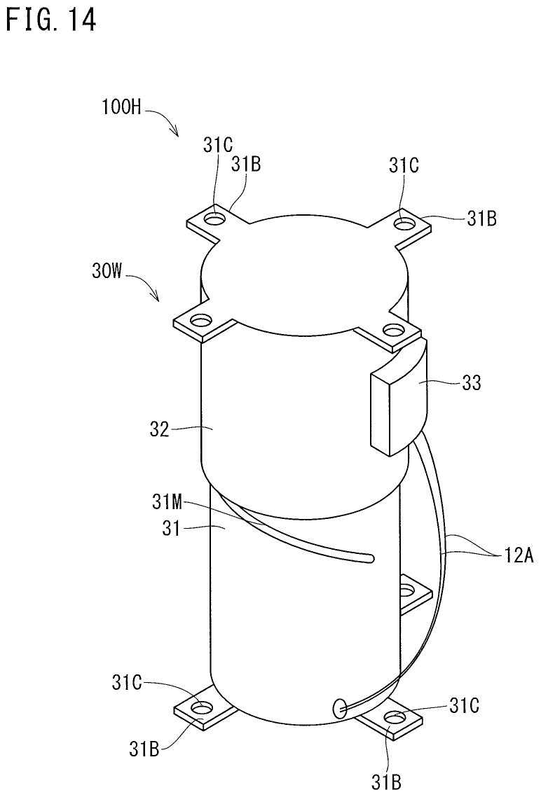

An electrical device 100H of the present embodiment is illustrated in FIG. 14, and includes a twist case 30W in which a screwing mechanism is added to the twist case 30V of the electrical device 100G of the tenth embodiment. Specifically, an outer surface of the one cylindrical body 31 of the twist case 30W is provided with an engagement portion 31M having a groove structure or a ridge structure extending in a spiral shape, and an inner surface of the other cylindrical body 32 is provided with an engagement portion (not illustrated) to be screwed with the engagement portion 31M. As a result, when the cylindrical bodies 31 and 32 of the twist case 30W rotate relative to each other, the magnet element 20 is torsionally deformed as well as being deformed by extension and compression. As a result, an induced current is induced in the electromagnetic induction coil 12.

### Twelfth Embodiment

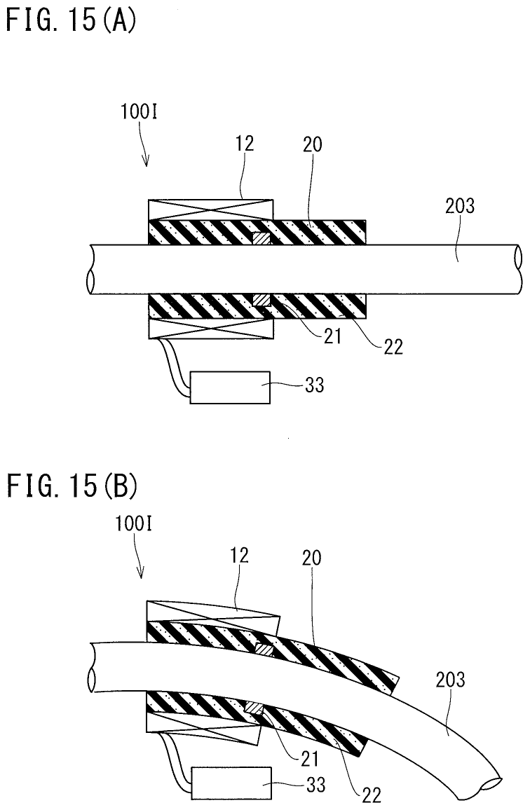

An electrical device 100I of the present embodiment is illustrated in FIG. 15. As illustrated in FIG. 15(A), the electrical device 100I includes a cylindrical magnet element 20 exactly fitted to a shaft 203 as a target whose bending deformation is to be detected, and the electromagnetic induction coil 12 fitted to the outside of the magnet element 20. In addition, the magnet part 21 is engaged with the inside of the magnet element 20. As illustrated in FIG. 15(B), the magnet element 20 and the electromagnetic induction coil 12 are bent and deformed together with the shaft 203. In addition, the electrical device 100I includes, for example, the rectifier 91 and the wireless module 92A similar to those of the electrical device 100B of the fifth embodiment, which are accommodated in the circuit case 33. When the magnet element 20 is bent and deformed along with the bending deformation of the shaft 203, the magnetic flux density passing through the electromagnetic induction coil 12 is changed to generate power, and the wireless module 92A of the load unit 92 receives the power and transmits a wireless signal.

### Thirteenth Embodiment

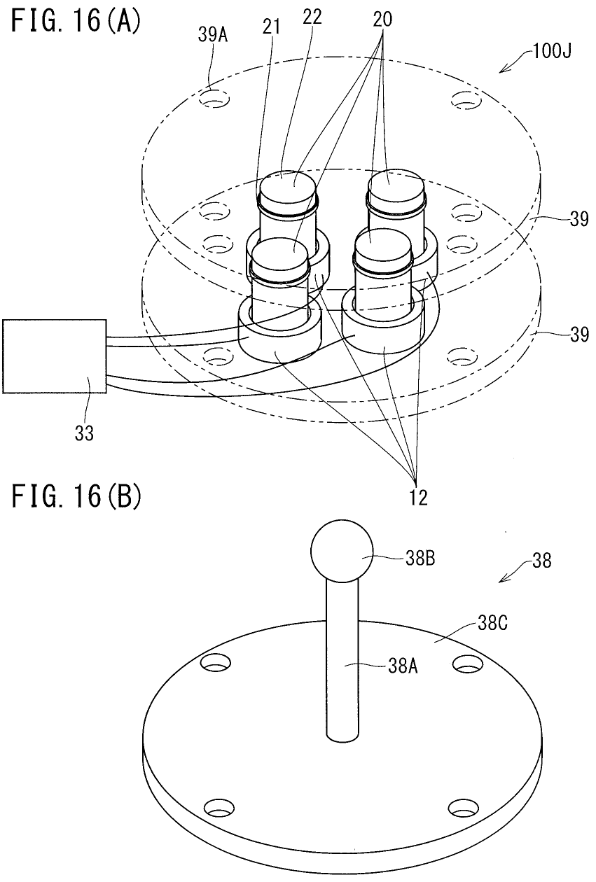

An electrical device 100J of the present embodiment is illustrated in FIG. 16(A), and has a structure in which a pair of non-magnetic disks 39 is provided to face each other, and a plurality of the magnet elements 20 are connected in parallel between the pair of disks 39. Specifically, the plurality of magnet elements 20 each have, for example, a columnar shape. In a portion inside outer edges of the pair of disks 39, the central axis of each magnet element 20 is disposed at a position that divides an imaginary circle being concentric with the central axis of the pair of disks 39 into a plurality of equal parts. Each magnet element 20 is fixed to the pair of disks 39 with an adhesive applied to the opposite end surfaces of the magnet element 20. A plurality of attachment holes 39A are formed in the outer edges of the pair of disks 39.

In addition, the electromagnetic induction coil 12 is fitted to the outside of each magnet element 20. A plurality of the rectifiers 91 and the wireless modules 92A described in the fifth embodiment are provided corresponding to the plurality of electromagnetic induction coils 12, and accommodated in the circuit case 33. Every time an induced current equal to or more than a predetermined magnitude flows through each electromagnetic induction coil 12, the wireless module 92A corresponding to the electromagnetic induction coil 12 transmits a wireless signal including information of an identification number unique thereto.

The electrical device 100J of the present embodiment is used by fixing the pair of disks 39 to a detection target. The plurality of electromagnetic induction coils 12 generate power according to a behavior in which the pair of discs 39 approaches or separates from each other, a behavior in which one of the discs 39 tilts in any direction with respect to the other disc 39, or a behavior in which one of the discs 39 rotates about the central axis with respect to the other disc 39, and outputs a wireless signal according to the power generation state.

In addition, as illustrated in FIG. 16(B), an additional component 38 having a support column 38A erected from the center of a disk 38C and a mass 38B provided at a distal end thereof is prepared, the disk 38C of the additional component 38 is overlapped and fixed to one of the disks 39 of the electrical device 100J, and the other disk 39 is fixed to a building, a vehicle, a ground, or the like, so that vibration or the like received by the electrical device 100J can be detected.

### Fourteenth Embodiment

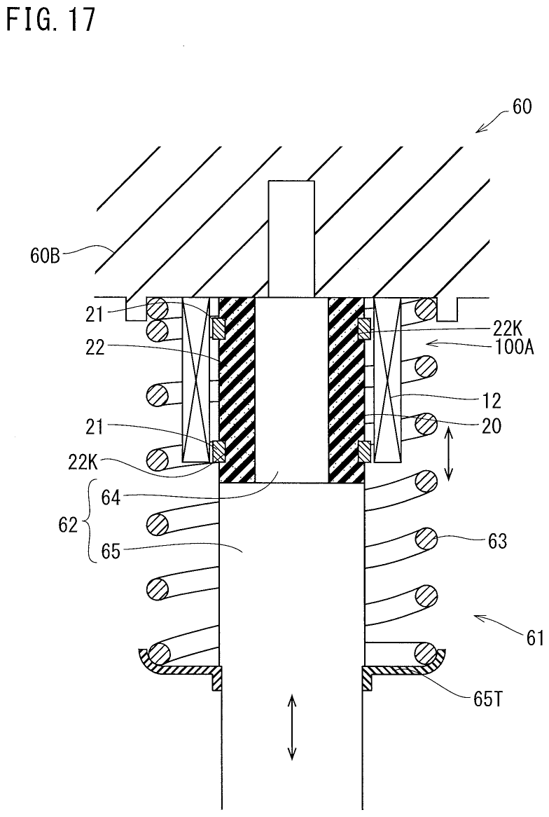

The electrical device 100A of the present embodiment differs from the above first embodiment in the disposition of the magnet part 21. As illustrated in FIG. 17, the magnet element 20 includes the support 22 having a shape such as a cylindrical shape and a columnar shape with a central axis, and includes a plurality of the magnet parts 21. The magnet parts 21 are attached to a plurality of positions in the axial direction of the support 22 in a separated state from each other. In an example illustrated in FIG. 17, the support 22 has a cylindrical shape, and the two magnet parts 21 are provided, and are attached to, for example, a position near one end (for example, a position near a lower end) and a position near the other end (for example, a position near an upper end) of the support 22. For example, the magnet parts 21 have an annular shape (for example, rigid rings), and are fitted to the constricted portions 22K (for example, annular grooves) formed in the support 22. The constricted portion 22K may be provided in a portion of the support 22 other than the portions to which the magnet parts 21 are fitted, or does not have to be provided therein (see FIG. 17). In addition, the constricted portions 22K do not have to be provided in the portions of the support 22 to which the magnet parts 21 are fitted. In this case, the constricted portion 22K may be provided in another portion of the support 22, or does not have to be provided. Other configurations of the present embodiment are similar to those of the above first embodiment.

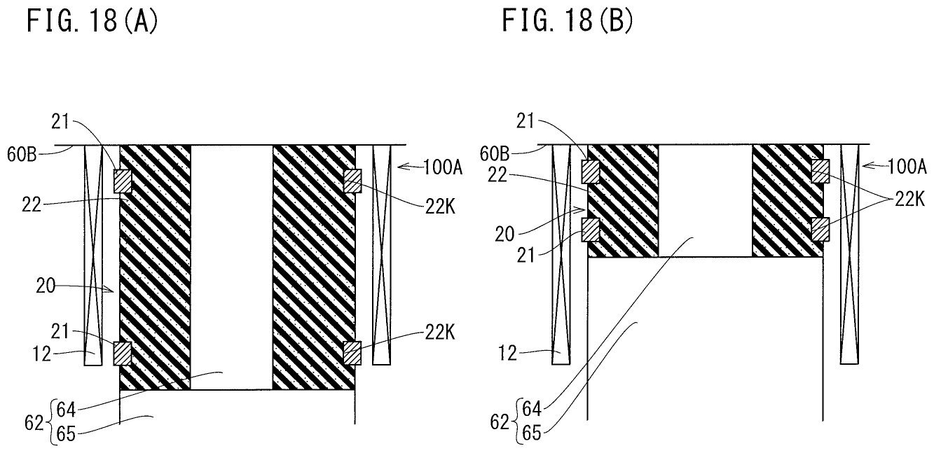

Similarly to the above first embodiment, in the electrical device 100A of the present embodiment, the magnet element 20 is set between the cylinder 65 and the vehicle body 60B. A change in a distance between the cylinder 65 and the vehicle body 60B extends and compresses the support 22 in the axial direction as illustrated in FIGS. 18(A) and 18(B). Here, in the magnet element 20 of the present embodiment, the magnet parts 21 are supported by the support 22, so that the magnet parts 21 move in the axial direction with respect to the electromagnetic induction coil 12 by the extension and compression of the support 22, and a distance between the magnet parts 21 also changes. This changes the density of magnetic flux passing through the electromagnetic induction coil 12 in a magnetic flux of a magnetic field by the magnet part 21, thereby generating an induced current. That is, the electrical device 100A generates power.

Here, the magnet parts 21 supported by the support 22 may be in opposite-pole facing disposition in which opposite poles face each other so as to attract each other (disposition in which the N pole and the S pole face each other), or may be in same-pole facing disposition in which the same poles face each other so as to repel each other (disposition in which the N poles or the S poles face each other). In the opposite-pole facing disposition, the magnet parts 21 attract each other, so that the support 22 can be more easily compressed in the axial direction. In addition, in the opposite-pole facing disposition, magnetic fluxes passing through the magnet parts 21 have the same direction. Therefore, it is considered that the magnetic flux density can be increased at the time of compression, and the density of magnetic flux passing through the electromagnetic induction coil 12 can be easily changed. As a result, a larger induced current can be expected to be generated. Meanwhile, in the same-pole facing disposition, when the support 22 is compressed in the axial direction, the magnet parts 21 repel each other, so that buckling of the support 22 can be inhibited. This makes it possible to inhibit so-called bottoming of the magnet element 20 at the time of compression, for example, in a case where the magnet element 20 is used for a bound stopper for reducing the bounce of the vehicle 60 in the shock absorber 62.

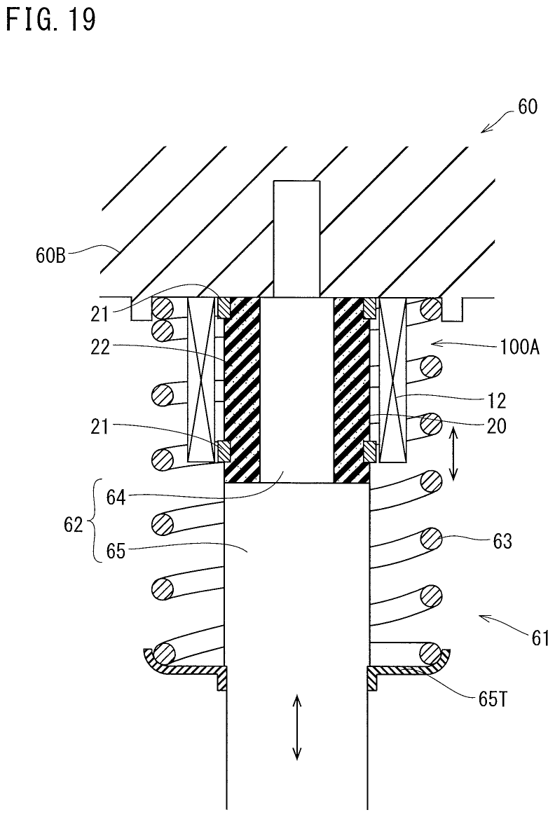

In a configuration in which one end of the support 22 to be extended and compressed is fixed to a support member (for example, the vehicle body 60B), in a case where the plurality of (for example, two) magnet parts 21 are provided in the axial direction of the support 22, the magnet part 21 closest to one end side (the uppermost magnet part 21 in an example of FIG. 19) of the magnet parts 21 may be fixed to the above support member as in the example illustrated in FIG. 19. For example, in this configuration, when the magnet part 21 closest to the one end side is configured as an electromagnet so as to be able to change the strength of its magnetic force, an attractive force or a repulsive force between the magnet parts 21 can be adjusted (in a case where a first magnet 21A is an electromagnet, for example, a configuration may be adopted in which a coil surrounding the first magnet 21A is provided and a current flows through the coil). As a result, for example, in a situation where the amount of compression of the support 22 increases (for example, a situation where the amplitude of vibration of the vehicle 60 increases), buckling (bottoming) of the support 22 can be further inhibited by making the repulsive force between the magnet parts 21 larger than usual.

### [Confirmation Experiment 1]

It has been confirmed by an experiment that power is generated by the electromagnetic induction coil 12 and the magnet element 20. Specifically, an induced electromotive force generated in the electromagnetic induction coil 12 has been confirmed as a substitute value for the induced current.

### I. Configuration of Electromagnetic Induction Device

In this experiment, the magnet element 20 was disposed coaxially with the electromagnetic induction coil 12, and the magnet element 20 was disposed such that its center position coincided with the center position of the electromagnetic induction coil 12 in a natural length state. The magnet element 20 was entirely accommodated in the electromagnetic induction coil 12, was disposed so as to align the axial direction with a vertical direction, and was compressed from one end side in the axial direction (from below) to be elastically deformed. Details of the electromagnetic induction coil 12 and the magnet element 20 are as follows.

### (1) Electromagnetic Induction Coil 12

The electromagnetic induction coil 12 formed of a copper wire and having a coil winding diameter (inner diameter) of 36 mm (36 @), an axial length of 70 mm, a wire diameter of 0.5 mm, a winding number of 1395, and a resistance of 13Ω was used.

### (2) Magnet Element 20

The magnet element 20 was used in which the magnet part 21 formed of a neodymium-based magnet sheet was stuck to the outer side surface of the support 22 made of a polyurethane foamed elastomer with a double-sided tape.

### (3) Support 22

The support 22 has a cylindrical shape with an outer diameter of 28 mm, an inner diameter of 10 mm, and an axial length of 42 mm, and includes the three constricted portions 22K. The support 22 also has an open-cell structure, and an expansion ratio of 2 times. Raw materials of the support 22 are as follows.

### [First Liquid]

Polyol; Polyester polyol (molecular weight: 2000, number of functional groups: 2, hydroxyl value: 56 mg KOH/g, product name: “POLYLITE OD-X-102”, manufactured by DIC Corporation)

Isocyanate; 1,5-naphthalene diisocyanate (NCO %: 40%, product name: “COSMONATE ND”, manufactured by Mitsui Chemicals, Inc.)

### [Second Liquid]

Catalyst; Amine catalyst, product name: “Addocat PP”, manufactured by Rhein Chemie Japan Co., Ltd.

Foaming agent; Mixed liquid containing castor oil and water, product number: “Addovat SV” (weight ratio of castor oil and water: 50:50), manufactured by Rhein Chemie Japan Co., Ltd.

### (4) Magnet Part 21

The magnet part 21 is a band-shaped sheet having a thickness of 2 mm and a width of 5 mm, and is stuck in a ring shape to the outer side surface of the support 22 between the first and second constricted portions 22K from the top of the outer side surface. In addition, the magnet part 21 has a surface magnetic flux density of 20 mT, and a magnetization direction along the axial direction of the support 22.

### II. Test Method

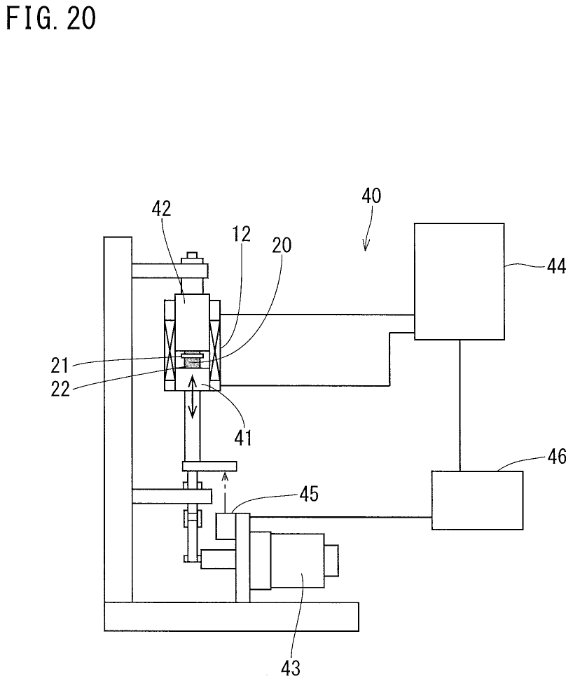

Using a testing apparatus 40 illustrated in FIG. 20, a voltage between opposite ends of the electromagnetic induction coil 12 was measured and evaluated by vibrating and deforming the magnet element 20 so as to repeat compression and restoration in the axial direction of the electromagnetic induction coil 12. In addition, the above voltage was measured by changing the frequency of vibration deformation of the magnet element 20 to 1 Hz, 3 Hz, 5 Hz, and 10 Hz. The amplitude level was 5 mm (displacement amount).

Details of the testing apparatus 40 are as follows. The testing apparatus 40 includes a piston 41 and a fixing member 42 that sandwich the magnet element 20 in the axial direction of the electromagnetic induction coil 12 inside the electromagnetic induction coil 12. The piston 41 receives power from a drive source 43 and vibrates in the axial direction of the electromagnetic induction coil 12 to vibrate and deform the magnet element 20. A distance between the fixing member 42 and the piston 41 is set to be equal to the natural length of the magnet element 20 when the piston 41 moves farthest from the fixing member 42 in a vibration stroke. That is, in this experiment, the fixing member 42 and the piston 41 are always in contact with the magnet element 20.

In addition, the opposite ends of the electromagnetic induction coil 12 are connected to an oscilloscope 44, which displays the induced electromotive force generated in the electromagnetic induction coil 12. Furthermore, the testing apparatus 40 is provided with a laser displacement meter 45 for detecting the vibration of the piston 41. The laser displacement meter 45 outputs a signal related to the amplitude, frequency, or the like of the piston 41 to the oscilloscope 44 via an amplifier unit 46, so that the amplitude or frequency of the vibration of the piston 41 can be confirmed by the oscilloscope 44.

### III. Test Result

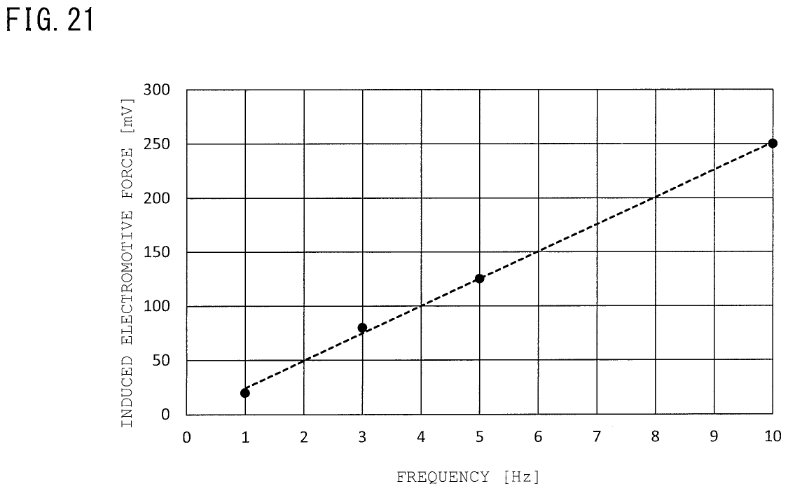

As illustrated in FIG. 21, it has been found that the induced electromotive force increases as the frequency increases. In addition, it has been confirmed that there is a correlation between the frequency and the induced electromotive force.

### [Confirmation Experiment 2]

It has been confirmed by an experiment that power is generated by the electromagnetic induction coil 12 and the magnet element 20 by using the testing apparatus 40 (see FIG. 20) similarly to confirmation experiment 1 described above. Specifically, an induced electromotive force generated in the electromagnetic induction coil 12 has been confirmed as a substitute value for the induced current. Hereinafter, in confirmation experiment 2, matters different from those of confirmation experiment 1 described above will be mainly described.

### I. Configuration of Electromagnetic Induction Device

In this experiment as well, the magnet element 20 was disposed coaxially with the electromagnetic induction coil 12, and the magnet element 20 was disposed such that its center position coincided with the center position of the electromagnetic induction coil 12 in a natural length state. The magnet element 20 was entirely accommodated in the electromagnetic induction coil 12, was disposed so as to align the axial direction with a vertical direction, and was compressed from one end side in the axial direction (from below) to be elastically deformed. Details of the electromagnetic induction coil 12 and the magnet element 20 are as follows.

### (1) Electromagnetic Induction Coil 12

Similarly to confirmation experiment 1 described above, in this experiment as well, the electromagnetic induction coil 12 formed of a copper wire and having a coil winding diameter (inner diameter) of 36 mm (36Φ), an axial length of 70 mm, a wire diameter of 0.5 mm, a winding number of 1395, and a resistance of 13Ω was used.

### (2) Magnet Element 20

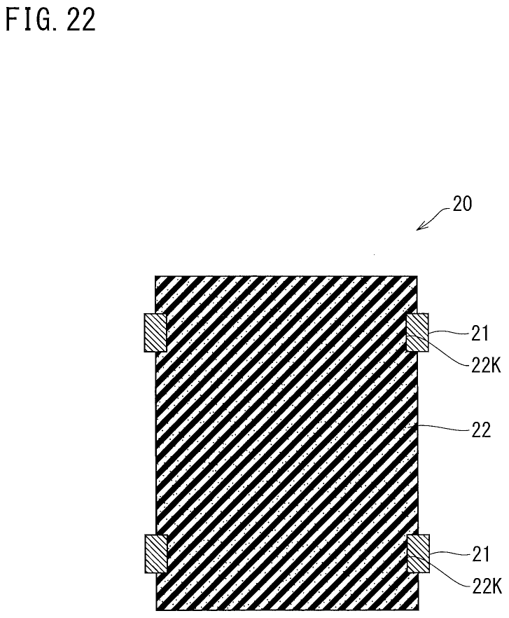

The magnet element 20 was used in which the magnet parts 21 having a ring shape of a neodymium-based magnet were fitted to the constricted portions 22K on the outer side surface of the support 22 made of a polyurethane foamed elastomer (see FIG. 22).

### (3) Support 22

As illustrated in FIG. 22, the support 22 has a columnar shape with an outer diameter of 25 mm and an axial length of 30 mm, and includes the two constricted portions 22K (annular grooves) to which the magnet parts 21 are fitted near opposite ends. The support 22 also has an open-cell structure. As the support 22, one having a low density with an apparent density of 0.2 g/cm³ and one having a high density with an apparent density of 0.4 g/cm³ were used (the high-density support 22 has higher elasticity, lower viscosity, and smaller Tan δ than the low-density support 22). Raw materials of the support 22 are as follows.

### [First Liquid]

Polyol; Polyester polyol (molecular weight: 2000, number of functional groups: 2, hydroxyl value: 56 mg KOH/g, product name: “POLYLITE OD-X-102”, manufactured by DIC Corporation)

Isocyanate; 1,5-naphthalene diisocyanate (NCO %: 40%, product name: “COSMONATE ND”, manufactured by Mitsui Chemicals, Inc.)

### [Second Liquid]

Catalyst; Amine catalyst, product name: “Addocat PP”, manufactured by Rhein Chemie Japan Co., Ltd.

Foaming agent; Mixed liquid containing castor oil and water, product number: “Addovat SV” (weight ratio of castor oil and water: 50:50), manufactured by Rhein Chemie Japan Co., Ltd.

### (4) Magnet Part 21

The magnet parts 21 having a ring shape (inner diameter: 20 mm, axial length: 6 mm, radial thickness: 3 mm) are fitted and attached to the two constricted portions 22K on the outer side surface of the support 22. The two magnet parts 21 are disposed symmetrically in the axial direction of the support 22, and these magnet parts 21 are separated from each other by 10 mm. In addition, the magnet parts 21 have a surface magnetic flux density of 20 mT, and a magnetization direction along the axial direction of the support 22.

### II. Test Method

Using a testing apparatus 40 illustrated in FIG. 20, a voltage between opposite ends of the electromagnetic induction coil 12 was measured and evaluated by vibrating and deforming the magnet element 20 so as to repeat compression and restoration in the axial direction of the electromagnetic induction coil 12. In addition, the above voltage was measured by changing the frequency of vibration deformation of the magnet element 20 to 1 Hz, 5 Hz, and 10 Hz. The amplitude level was 3 mm (displacement amount). Similarly to confirmation experiment 1 described above, in the testing apparatus 40 (see FIG. 20), the piston 41 and the fixing member 42 sandwich the magnet element 20 in the axial direction of the electromagnetic induction coil 12 inside the electromagnetic induction coil 12.

### III. Test Result

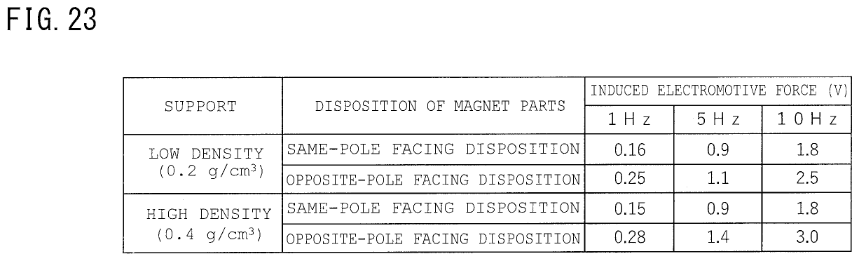

As illustrated in FIG. 23, it has been found that the induced electromotive force is generated in both of a case where the two magnet parts 21 are in the opposite-pole facing disposition and a case where the two magnet parts 21 are in the same-pole facing disposition. It has also been found that the induced electromotive force is larger in the opposite-pole facing disposition than in the same-pole facing disposition. This is considered to be because the magnetic forces cancel each other in the same-pole facing disposition. In this experiment as well, it has been found that the induced electromotive force increases as the frequency increases. It has been confirmed that there is a correlation between the frequency and the induced electromotive force.

### Other Embodiments

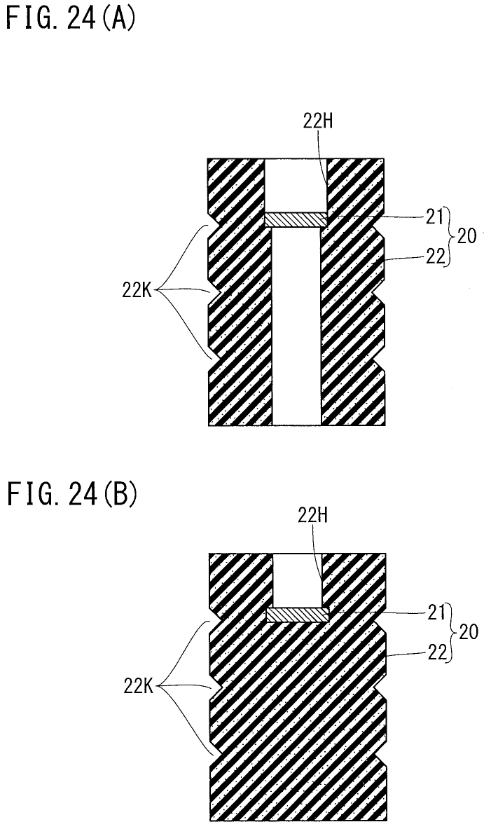

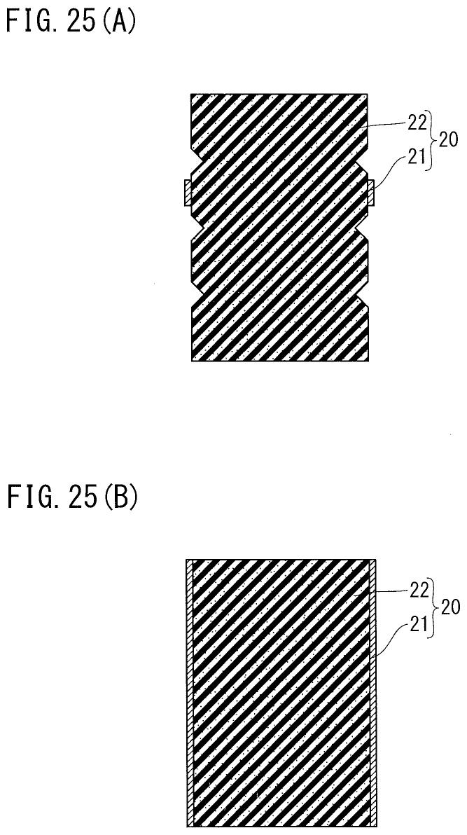

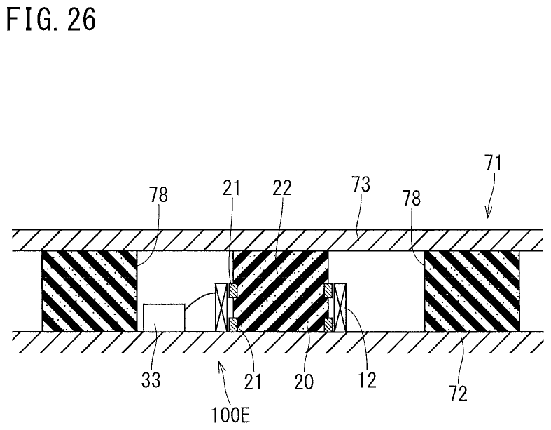

(1) In the above embodiments, the magnet part 21 is fitted from one end of the support 22 after the molding of the support 22. However, the magnet part 21 may be attached to the support 22 by insert molding. In addition, in a case where the magnet part 21 is attached by insert molding, the magnet part 21 may be attached to the outer side surface of the support 22, or the magnet part 21 may be incorporated in the support 22.
(2) As a configuration in which the magnet part 21 is incorporated in the support 22, for example, a configuration in which an accommodation hole 22H is formed at the center of the support 22 and the magnet part 21 having, for example, a spherical or disk shape is accommodated in the accommodation hole 22H as illustrated in FIGS. 24(A) and 24(B) may be adopted other than the above insert molding. The accommodation hole 22H does not have to axially pass through the support 22 as illustrated in FIG. 24(B), or may axially pass through the support 22 as illustrated in FIG. 24(A).
(3) In the magnet element 20 of the above embodiments, the rigid ring is exemplified as the magnet part 21. However, for example, the magnet part 21 having a sheet shape may be stuck to the outer side surface of the support 22 with an adhesive as illustrated in FIG. 25(A). Or, the outer side surface of the support 22 may be coated with an elastic resin containing a magnetic powder, and this elastic resin layer may be used as the magnet part 21 as illustrated in FIG. 25(B). The elastic resin layer may be formed on the entire outer side surface as illustrated in FIG. 25(B), or may be formed only partially.
(4) In addition, the magnet part 21 of the magnet element 20 is not limited to the ring shape. For example, the magnet part 21 having a disk shape may be intermittently disposed on the outer side surface or an inner side surface of the support 22, or the magnet part 21 may be disposed along the axial direction on a part of the outer side surface or the inner side surface of the support 22.
(5) For example, a configuration may also be adopted in which a magnetic sensor such as a Hall element, a TMR element (tunnel magneto-resistive effect element), a GMR element (giant magneto-resistive effect element), or an AMR element (anisotropic magneto-resistive effect element) is disposed to face the magnet element 20 as a device to detect the behavior or the like of a member using a change in magnetic flux density accompanying the elastic deformation of the magnet element 20.
(6) Similarly to the electrical device 100J of the above thirteenth embodiment that can be used for torsional deformation, bending deformation, and extension and compression deformation, all the electrical devices 100A to 100I described above may be used in other usages. In addition, electrical loads included in the load units of the electrical devices 100A to 100I may be appropriately changed.
(7) In the above embodiments, the magnetization direction of the magnet element 20 is aligned with the axial direction of the electromagnetic induction coil 12, but may be inclined with respect to the axial direction of the electromagnetic induction coil 12.
(8) In the above embodiments, the electromagnetic induction coil 12 and the magnet element 20 are coaxially disposed. However, the central axes of the electromagnetic induction coil 12 and the magnet element 20 may be shifted from each other and disposed in parallel, or may be inclined with respect to each other.
(9) Since the main part of the magnet element 20 is the support 22 made of an elastic resin, the magnet element 20 can be easily cut into any desired shape.
(10) In the above embodiments, 1, 5-naphthalene diisocyanate (NDI) is used as the raw material isocyanate of the magnet element 20, but diphenylmethane diisocyanate (MDI) may be used.
(11) In the electrical device 100E of the above eighth embodiment, a plurality (for example, two) of the magnet parts 21 may be disposed so as to be spaced apart in the axial direction of the support 22 as illustrated in FIG. 26.

### Note

Hereinafter, features of an invention group extracted from the above embodiments will be described while describing their effects or the like as necessary.

### Feature 1

A magnet element including:
a magnet part; and
a support made of an elastic resin and configured to support the magnet part.

According to the magnet element of feature 1, it is possible to provide a novel magnet element in which the support made of an elastic resin supports the magnet part.

### Feature 2

The magnet element according to feature 1, wherein the support has a columnar or cylindrical shape and includes a constricted portion on an outer side surface thereof.

According to feature 2, the constricted portion facilitates extension and compression of the support.

### Feature 3

The magnet element according to feature 1 or 2, wherein the magnet part is disposed at one end in an extension and compression direction of the support.

According to feature 3, a moving amount of the magnet part in the extension and compression direction can be increased by disposing the magnet at one end in the extension and compression direction of the support.

### Feature 4

The magnet element according to any one of features 1 to 3, wherein the magnet part has a ring shape.

### Feature 5

The magnet element according to feature of any one of features 1 to 4, wherein the magnet part is a sheet.

The ring-shaped magnet part may be a rigid ring, may be a ring formed by winding a sheet as in, for example, feature 5, or may be a magnet layer formed by coating the support.

### Feature 6

The magnet element according to any one of features 1 to 5, wherein the magnet part is disposed on a surface of the support.

### Feature 7

The magnet element according to any one of features 1 to 5, wherein the support incorporates the magnet part.

The magnet part may be disposed on the surface (outer side surface) of the support as in feature 6, or may be incorporated in the support as in feature 7.

### Feature 8

The magnet element according to any one of features 1 to 7, wherein the support is made of a foamed elastomer.

According to feature 8, since the support is a foamed elastomer, air bubbles are crushed when the support is compressed, and the air bubbles expand when the support is extended. As a result, it is possible to inhibit a change in size in a direction orthogonal to the extension and compression direction accompanying the extension and compression deformation, thereby it becomes possible to inhibit interference between the support and components around the support.

### Feature 9

The magnet element according to any one of features 1 to 8, wherein a plurality of the magnet parts are provided in the extension and compression direction of the support.

### Feature 10

The magnet element according to any one of features 1 to 9, wherein a pair of the magnet parts is provided in the extension and compression direction of the support.

### Feature 11

An electrical device including:
the magnet element according to any one of features 1 to 10; and
an electromagnetic induction coil.

According to feature 11, it is possible to generate an induced electromotive force by the magnet element and the electromagnetic induction coil to generate power.

### Feature 12

An electrical device including:
a rectifier configured to rectify an induced current induced in the electromagnetic induction coil; and
a load unit configured to receive power from the rectifier and operate.

According to feature 12, the current rectified by the rectifier can be applied to the load unit to drive the load unit.

### Feature 13

The electrical device according to feature 12, wherein the load unit includes a wireless circuit configured to output a wireless signal according to the power received from the rectifier.

Since the electrical device of feature 13 includes the wireless circuit in addition to performing self-power generation, the degree of freedom in selecting an installation place is increased.

### Feature 14

The electrical device according to feature 13, wherein the wireless circuit outputs a wireless signal every time the power is received from the rectifier to notify that the magnet element has received an external force.

The electrical device of feature 14 can be installed at a place receiving an external force to monitor an external force state from a remote location.

### Feature 15

The electrical device according to any one of features 12 to 14, wherein the load unit includes:
a detection circuit configured to generate detection data for specifying the external force based on the induced current; and
a wireless circuit configured to wirelessly transmit the detection data.

Since the electrical device of feature 15 generates the detection data for specifying the external force based on the induced current and then wirelessly transmits the detection data, it is possible to collect data that is hardly affected by noise due to wireless transmission at a remote location away from the electrical device.

### Feature 16

The electrical device according to any one of features 12 to 15, wherein the rectifier includes a secondary battery that is charged by the induced current and is able to supply power to the load unit.

In feature 16, since the secondary battery is provided, power supply to the load unit becomes stable.

Although specific examples of the technology included in the claims are disclosed in the present specification and the drawings, the technology described in the claims is not limited to these specific examples, and includes those obtained by variously modifying and changing the specific examples, and also includes those obtained by singly extracting a part from the specific examples.

### DESCRIPTION OF THE REFERENCE NUMERALS

12 Electromagnetic induction coil
20, 20W Magnet element
21 Magnet part
22, 22W Support
22K Constricted portion
100A to 100J Electrical device

1.-8. (canceled)

9. A magnet element comprising:
a magnet part; and
a support made of an elastic resin and configured to support the magnet part, wherein the support is a foam.

10. The magnet element according to claim 9, wherein the support has a columnar or cylindrical shape and includes a constricted portion on an outer side surface of the support.

11. The magnet element according to claim 9, wherein the magnet part is disposed at one end in an extension and compression direction of the support.

12. The magnet element according to claim 10, wherein the magnet part is disposed at one end in an extension and compression direction of the support.

13. The magnet element according to claim 9, wherein the magnet part has a ring shape.

14. The magnet element according to claim 10, wherein the magnet part has a ring shape.

15. The magnet element according to claim 9, wherein the magnet part is a sheet.

16. The magnet element according to claim 10, wherein the magnet part is a sheet.

17. The magnet element according to claim 9, wherein the magnet part is disposed on a surface of the support.

18. The magnet element according to claim 10, wherein the magnet part is disposed on a surface of the support.

19. The magnet element according to claim 9, wherein the support incorporates the magnet part.

20. The magnet element according to claim 10, wherein the support incorporates the magnet part.

21. An electrical device comprising:
the magnet element according to claim 9; and
an electromagnetic induction coil.

22. An electrical device comprising:
the magnet element according to claim 10; and
an electromagnetic induction coil.
